(19) United States
(12) Patent Application Publication
(10) Pub. No.: US 2012/0040106 A1
(43) Pub. Date: Feb. 16, 2012

(54) APPARATUS FOR IMPREGNATING A FIBER MATERIAL WITH A RESIN AND METHODS FOR FORMING A FIBER-REINFORCED PLASTIC PART

(76) Inventors: Stefan SIMMERER, Essen (DE); Uli RAMM, (US); Markus GRIESEL, (US); Jan Willem BAKHUIS, Nijverdal (NL)

(21) Appl. No.: 12/856,769

(22) Filed: Aug. 16, 2010

(51) Int. Cl. B05D 3/12; B05D 3/02; B05C 13/00; B05D 3/00

(52) U.S. Cl. 427/560; 427/346; 427/294; 427/180; 427/314; 118/57

(57) ABSTRACT

A method for forming a fiber-reinforced plastic part is provided. The method includes providing a mold, providing a vibration generator, placing a fiber material in the mold, infusing the fiber material with a resin while the fiber material and/or the resin are exposed to vibrations, and curing the resin.

### BACKGROUND OF THE INVENTION

The subject matter described herein relates generally to methods and systems for forming fiber-reinforced plastic parts, and, more particularly, to methods and systems for forming fiber-reinforced plastic parts having a high fiber volume content such as a spar cap of an aircraft wing or a wind turbine rotor blade.

At least some known wind turbines include a tower and a nacelle mounted on the tower. A rotor is rotatably mounted to the nacelle and is coupled to a generator by a shaft. A plurality of rotor blades extend from the rotor. The blades are oriented such that wind passing over the blades turns the rotor and rotates the shaft, thereby driving the generator to generate electricity.

Besides shape, the size and weight of rotor blades are factors that contribute to energy efficiency and energy yield, respectively, of wind turbines. As rotor blade sizes grow, the energy yield typically increases. Accordingly, there are ongoing efforts to increase rotor blade size and to decrease rotor blade weight at given rotor blade strength. Currently, large wind turbines having rotor blade assemblies of up to 126 meters in diameter are capable of generating several megawatts of power. The desirable long term stability and structural integrity of the rotor blades typically results in production costs that increase with the size of the rotor blade. Typically, larger rotor blades are at least partially manufactured from or as fiber-reinforced plastic parts. Accordingly, there is need for improved manufacture of fiber-reinforced plastic parts, in particular of load bearing fiber-reinforced plastic parts such as spar caps of rotor blades.

### BRIEF DESCRIPTION OF THE INVENTION

In one aspect, a method for forming a fiber-reinforced plastic part is provided. The method includes providing a mold, providing a vibration generator, placing a fiber material in the mold, infusing the fiber material with a resin while the fiber material and the resin are exposed to vibrations, and curing the resin.

In another aspect, a further method for forming a fiber-reinforced plastic part is provided. The method includes providing a mold, providing a vibration generator for generating a sound field, wetting a fiber material with a resin, placing the fiber material into a mold, exposing the fiber material and the resin to a sound field, and curing the resin.

In yet another aspect, an apparatus for impregnating a fiber material with a resin is provided. The apparatus is selected from a group consisting of an apparatus including a mold for infusing the fiber material with the resin and a sound source which is adapted to expose the fiber material and the resin to a sound field during infusion, an apparatus including at least one infusion roller for wetting the fiber material with the resin and a sound source which is adapted to expose the fiber material and the resin to a sound field when the fiber material passes the at least one infusion roller and/or after passing the at least one infusion roller, and an apparatus including at least one pinch roller adapted to press the resin-wetted fiber material and a sound source which is adapted to expose the resin-wetted fiber material to a sound field prior to and/or during and/or after passing the at least one pinch roller.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine;

FIG. 2 is a perspective view of an exemplary blade that may be used as a rotor blade of the wind turbine shown in FIG. 1;

FIG. 3 is a schematic sectional view of the blade shown in FIG. 2;

FIG. 4 is a schematic drawing of a mold for forming a fiber-reinforced plastic part according to an embodiment;

FIG. 5 is a schematic drawing of a mold for forming a fiber-reinforced plastic part according to another embodiment;

FIG. 6 is a schematic drawing of a mold for forming a fiber-reinforced plastic part according to still another embodiments;

FIG. 7 is a schematic drawing of a resin bath for impregnating a fiber material according to an embodiment;

FIG. 8 is a schematic drawing of a mold and an apparatus for penetrating a fiber material with a resin according to embodiments;

FIG. 9 illustrates a method for forming a fiber-reinforced plastic part according to an embodiment;

FIG. 10 illustrates a method for forming a fiber-reinforced plastic part according to another embodiment;

FIG. 11 illustrates a method for forming a fiber-reinforced plastic part according to yet another embodiment;

FIG. 12 illustrates a method for forming a fiber-reinforced plastic part according to a further embodiment;

FIG. 13 illustrates a method for forming a fiber-reinforced plastic part according to yet another embodiment;

FIG. 14 illustrates methods for forming fiber-reinforced plastic parts according to embodiments.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include apparatuses for impregnating a fiber material with a resin and methods for forming a fiber-reinforced plastic part. The apparatuses and methods facilitate a faster and/or more uniform infusion of the fiber material with the resin by applying a sound field and vibrations, respectively, to the resin and the fiber material. Furthermore, more complex, e.g. thicker fiber materials may be infused. Thus, the curing cycle and overall production cost may be reduced. Furthermore, the likelihood of forming dry spots may be reduced and hence the quality of fiber-reinforced plastic parts increased. In particular, fiber-reinforced plastic parts for carrying high loads such as a root section of a blade, and shear webs and spar caps used in wind turbine rotor blades and aircraft wings, may be fabricated using the described apparatuses and/or methods.

As used herein, the terms “blade” and “wing” are intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. The term “wind turbine” as used herein shall particularly embrace devices that generate electrical power from rotational energy generated from wind energy.

The terms “fiber-reinforced composite” and “fiber-reinforced plastic” are used synonymously herein. As used herein, the terms “fiber-reinforced composite” and “fiber-reinforced plastic” intend to describe composite materials having a polymer matrix which is reinforced with fibers. Fiber-reinforced plastic parts are commonly used in the aerospace, automotive, marine, and construction industries. Typical examples include, without being limited thereto, vehicle parts, the nacelle and the rotor blades of wind turbines, a blade of a helicopter propeller, and parts of an aircraft such as the aircraft fuselage, aircraft wings and a blade of an aircraft propeller. Herein, the embodiments are mainly explained with respect to rotor blades of a wind turbine but typically also apply to other fiber-reinforced plastic parts.

Usually, the fiber-reinforced composite is formed by impregnation of a fiber material with and, thereafter, curing of a resin or plastic. The fiber material may be made available in any conventional form such as loose fibers, fiber mats or bundles of fibers such as rovings. Fiber mats may be provided as braided, unidirectional, woven fabric, knitted fabric, swirl fabric, felt mat, wound, and the like. The strength of the fibers may be further increased by using techniques known in the art, such as, but not limited to, forming a plurality of layers or plies, by orientation of the fibers in a direction, and similar methods. It should be further understood, that the term “fiber mat” can also refer to a stack of at least two fiber mats. Fiber-reinforced plastic parts capable of bearing heavy loads are typically made of biaxial fiber mats, stack of biaxial fiber mats, and/or rovings as fiber material.

Exemplary fibers, that may be used in fiber material, include carbon fibers (e.g. TORAYCA® T800, TORAYCA® T700, TORAYCA® T620, and TORAYCA® T600 from Toray Industries, Inc.; MAGNAMITE® IM7 and MAGNAMITE® AS4 from Hexcel Corporation; and BESFIGHT® STS and BESFIGHT® HTS from Toho Tenax, Inc.), glass fibers (e.g. quartz, E-glass, S-2 glass, Rglass from suppliers such as PPG, AGY, St. Gobain, Owens-Corning, or Johns Manville), polyester fibers, polyamide fibers (such as NYLON™ polyamide available from E.I. DuPont, Wilmington, Del., USA), aromatic polyamide fibers (such as KEVLAR™ aromatic polyamide available from E.I. DuPont, Wilmington, Del., USA; or P84™ aromatic polyamide available from Lenzing Aktiengesellschaft, Austria), polyimide fibers (such as KAPTON™ polyimide available from E.I. DuPont, Wilmington, Del., USA), extended chain polyethylene (such as SPECTRA™ polyethylene from Honeywell International Inc., Morristown, N.J., USA; or DYNEEMA™ polyethylene from Toyobo Co., Ltd., or DSM, boron fibers, and the like.

Typically, the resin comprises at least one curable monomer. The monomers may have at least one isocyanate unit, ester unit, ethylenic unit, cyclic ether unit, or epoxide unit, oxetane unit, or the like, or combinations thereof. Suitable curable monomers comprise unsaturated polyester such as POLYLITE® polyester resin available from Reichhold, SYNOLITE® polyester resin available from DSM, AROPOL™ polyester resin available from Ashland; vinyl esters such as DION®, NORPOL®, and HYDREX® resins available from Reichhold, DERAKANE®, DERAKANE MOMENTUM® and HETRON® resins available from Ashland, ATLAC E-NOVA® resin available from DSM; acrylates, diacrylates, dimethacrylates, multi-functional acrylates and multifunctional methacrylates such as polyester acrylates, epoxy acrylates and urethane acrylates, and the like, available from such companies as Cytec Surface Specialties, Sartomer, Rahn, and BASF. The curable monomer is typically present in a range of from about 10% by weight to about 90% by weight, based on the total weight of the fiber composite, and more preferably, in a range of from about 20% by weight to about 80% weight, based on the total weight of the fiber composite.

Suitable resins comprising at least one cyclic ether unit comprise aliphatic epoxy resins, cycloaliphatic epoxy resins such as ERL-4221, CYRACURE™ UVR-6110, CYRACURE™ UVR-6107, and CYRACURE™ UVR-6105 from Dow Chemical Company and UVACURE® 1500 from Cytec Surface Specialties; bisphenol-A epoxy resins, bisphenol-F epoxy resins, phenol novolac epoxy resins, cresol-novolac epoxy resins, biphenyl epoxy resins, multi-functional epoxy resins (i.e. epoxy resins comprising two or more epoxy groups), naphthalene epoxy resins (e.g., EPICLON® EXA-4700 from Dainippon Ink and Chemicals), divinylbenzene dioxide, 2-glycidylphenylglycidyl ether, dicyclopentadiene-type epoxy resins (e.g., EPICLON® HP-7200 from Dainippon Ink and Chemicals), multi-aromatic resin type epoxy resins, or the like, or combinations thereof. All of these classes of epoxy resins are known in the art and are widely available and preparable by known methods. Further, latent curing agents for epoxy resins from CTP GmbH and BASF such as Baxxodur may be used. Further examples include EPIKOTE™ systems of Hexion Specialty Chemicals, such as EPIKOTE™ Resin MGS® RIMR 135 and EPIKURE™ Curing Agent MGS® RIMH 134-RIMH 137, and Epikote™ Resin MGS® RIMR 145 and Epikure™ Curing Agent MGS RIMH 145. Other illustrative examples of particular suitable epoxy resins and curing processes are described, for example, in U.S. Pat. Nos. 4,882,201, 4,920,164, 5,015,675, 5,290,883, 6,333,064, 6,518,362, 6,632,892, 6,800,373; U.S. Patent Application Publication No. 2004/0166241, and WO 03/072628 A1. Multi-functional oxetane resins may also be applied.

Any of these resins should be selected with respect to a particular fiber-reinforcement for producing a fiber-reinforced composite part of the wind turbine with the desired mechanical and environmental properties. The resin is usually degassed under vacuum after mixing of a hardener/catalyst into the resin, to eliminate or remove all entrapped air from the liquid resin. The resin should typically be capable of proceeding through a vacuum pressure cycle environment of heat and time without formation of gas bubbles or voids.

Further, fillers may be present in fiber composites. Fillers may comprise organic or inorganic fillers, reinforcing fillers, extending fillers, nanoparticles, or the like, or mixtures thereof. In particular embodiments, the filler generally comprises a reinforcing filler, such as, but not limited to, a fiber having an ultimate strength that is higher than the ultimate strength of stainless steel. The fillers may be UV transparent fillers such as, but not limited to, glass, silica, fumed silica, alumina, zirconium oxide, nanoparticles, and the like. Alternately, the fillers may be UV opaque fillers such as, but not limited to, carbon fibers, carbon black, silicon carbide, boron nitride, zirconium oxide, titanium dioxide, chalk, calcium sulfate, barium sulfate, calcium carbonate, silicates such as talc, mica or kaolin, silicas, aluminum hydroxide, magnesium hydroxide, or organic fillers such as polymer powders, polymer fibers, or the like. In the present context, UV opaque means that the material either blocks UV radiation, or absorbs UV radiation, or both. Those skilled in the art will recognize that, depending upon such factors as physical form or method of synthesis, certain fillers may be either UV opaque or UV transparent. Mixtures of more than one filler may also be used. The filler may be present in the composition in a range from about 1% to about 90%, and more typically in a range from about 10% to about 80% by weight, based on the total weight of the fiber composite. More preferably, the filler may be present in a range of from about 30% to about 75% by weight, based on the total weight of the fiber composite.

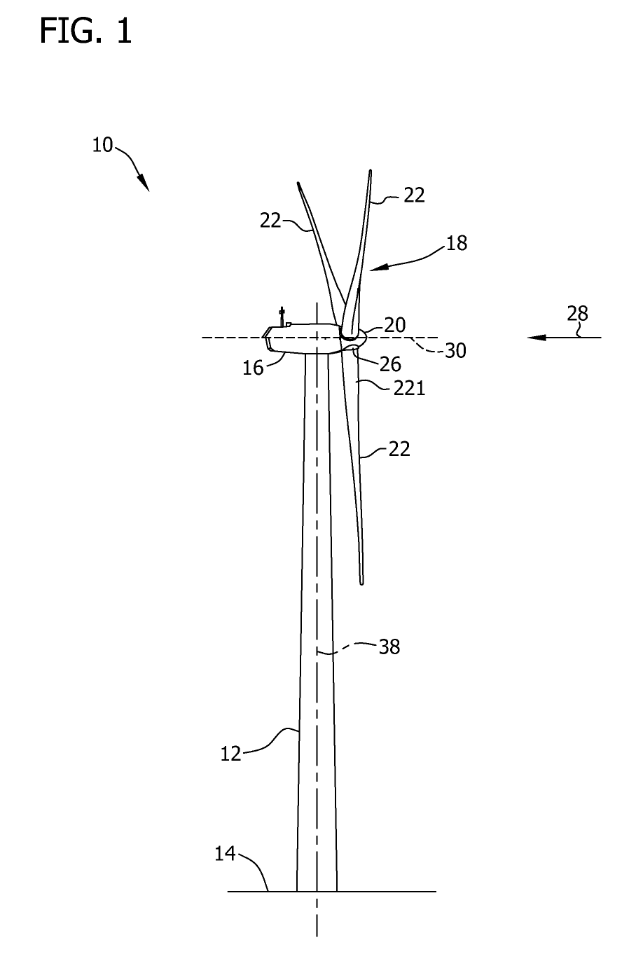

FIG. 1 shows a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 221 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 90 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. Further, in the exemplary embodiment, as direction 28 changes, a yaw direction of nacelle 16 may be controlled about a yaw axis 38 to position rotor blades 22 with respect to direction 28. As rotor blades 22 are rotated and subjected to centrifugal forces, rotor blades 22 are also subjected to various forces and moments. As such, rotor blades 22 are desired to bear heavy and varying mechanical loads over a long time.

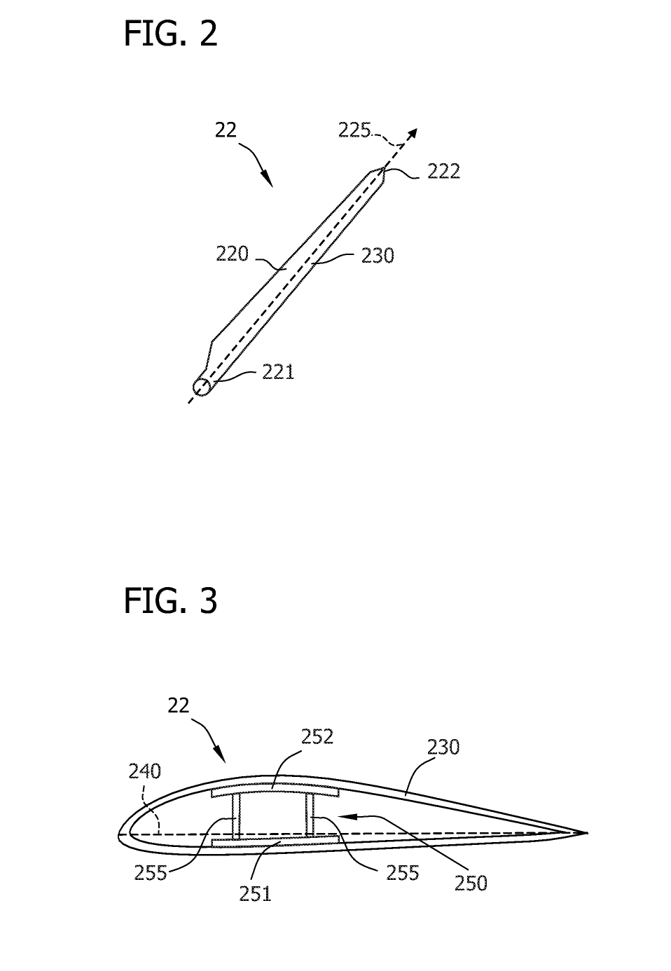

FIG. 2 illustrates in a schematic view of a blade 22 for use as a rotor blade 22 in the wind turbine 10 of FIG. 1. The blade 22 is shaped as a hollow aerodynamic profile body which extends in a longitudinal direction from a blade root or flange 221 to a rotor blade tip 222. This longitudinal direction defines a longitudinal blade axis 225. The blade root 221 is typically mounted to a rotatable hub of the wind turbine. The aerodynamic profile is formed by an outer surface of a shell 230. To minimize weight, the outer shell 230 is typically comparatively thin. Accordingly, mechanical stability and stiffness, respectively, are typically mainly achieved by an internal spar which extends along a center portion 220 of the blade. FIG. 3 illustrates this in more detail.

FIG. 3 shows the blade 22 shown in FIG. 2 in a schematic cross section which is perpendicular to the longitudinal blade axis. The exemplary rotor blade 22 includes spar 250 within the shell 230. The shell 230 is typically manufactured from layers of fiber composite and a lightweight core material and defines the exterior aerodynamic shape or airfoil of blade 22. Spar 250 includes two spar caps, namely a bottom spar cap 251 and a top spar cap 252. Spar caps 251, 252 extend along the longitudinal direction on the lower and upper interior side of the rotor blade 22, respectively, and provide increased rotor blade strength. Typically, the spar caps 251 and 252 are formed as fiber-reinforced plastic parts. One or more shear webs 255 extend generally perpendicular to and between the top spar cap 252 and the bottom spar cap 251.

Further, rotor blade 22 may be fabricated from two blade halves which are divided along the cord-line 240. The blade halves are typically formed in a mold by lamination of fiber mats. In parallel, or after forming the outer half shells of the blade halves, the upper spar cap 252 and the lower spar cap 251 are laminated and glued to the blade halves, respectively. Thereafter, the two blade halves are mounted together and shear webs 255 are mounted between the spar caps 251 and 252, typically by gluing. The blade halves may already be fastened together by the manufacturer or during erection of the wind turbine.

Typically, the spar caps are formed in a mold as glass fiber-reinforced plastic parts or carbon fiber-reinforced plastic parts. The spar caps are typically formed from biaxial fiber mats having a high fiber volume content, stacks of such fiber mats, or pressed rovings. This provides sufficient mechanical stability to the blades. As used herein, the term “high fiber volume content” intends to describe a fiber content in a range from about 55 vol. % to about 58 vol. %.

According to embodiments of the invention, the resin and, consequently, the fiber material are exposed to vibrations, typically infrasound vibrations and/or ultrasound vibrations, while the resin is penetrating the fiber material. Vibrations may result in a reduced viscosity of the resin and an increased wetting speed of the fiber material, respectively. Accordingly, penetration speed may be improved. Further, small air bubbles that may be formed during resin penetration may more easily escape from the wetted fiber material when exposed to vibrations. Accordingly, the size and/or number of small air bubbles in the resin impregnated fiber material may be reduced. Thus, the number and/or size of dry spots in the formed fiber-reinforced plastic parts may be reduced. Accordingly, the quality of the cured product may be improved.

The term “vibration”, as used herein, intends to describe mechanical oscillations of a material about an equilibrium point at a given temperature. The mechanical oscillations may be periodic and are typically induced by one or more sound sources or emitters. The frequency of the mechanical oscillations may range from below one Hz to several 100 MHz. In other words, the vibrations may be infrasound vibrations having frequencies below 20 Hz, acoustic vibrations in a frequency range from about 20 Hz to about 20 kHz or ultrasound vibrations in a frequency range from about 20 kHz to about 200 MHz. The frequency of the vibrations may be fixed or variable. Furthermore, several frequencies may be superimposed to from a specific sound profile. For example, a vibration of a first frequency which increases the wetting speed of the fiber material, e.g. an infrasound vibration, may be superimposed with a vibration of a second frequency enhancing the degassing of small air bubbles, e.g. an ultrasound vibration, may be superimposed. The vibrations are typically induced by one or more sound sources or vibration generators. The terms “sound source” and “vibration generator” are used synonymously herein. The terms “sound source” and “vibration generator”, as used herein, intend to describe any device designed to induce mechanical oscillations of a surrounding or adjoining material such as air or another device. Typical examples include, without being limited thereto, a loud speaker, an ultrasound transducer, a shaker and a vibration sander.

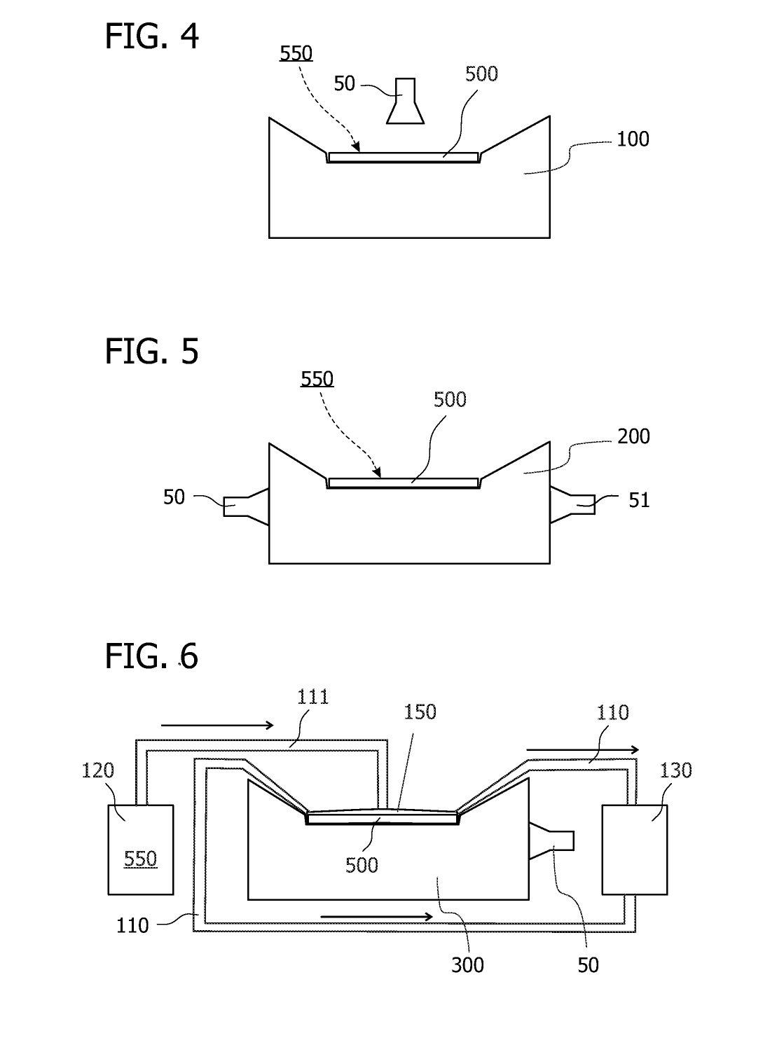

FIG. 4 schematically illustrates an embodiment of a mold 100 for forming a fiber-reinforced plastic part. The mold 100 is equipped with a sound source 50 such as a loud speaker or an ultrasound transmitter. In the embodiment shown, the sound source 50 is arranged above mold 100. Accordingly, a fiber material 500 placed into mold 100 may be exposed to a sound field. The sound field is transmitted from the sound source 50 to the mold 100 via air during wetting and/or infusion of the fiber material 500 with a resin 550 as indicated by the dashed arrow. In doing so, the resin 550 is also exposed to the sound field. The sound field causes vibrations of the fiber material 500 and the resin 550. This may result in an increasing penetration speed of the resin 550. Thus, the time of the curing cycle may be reduced. Furthermore, the resin may be adjusted to a shorter pot life or working life. Accordingly, the production capacity of the mold 100 may be increased and the production costs of the formed fiber-reinforced plastic parts reduced. Impregnation or wetting of the fiber material 500 may be improved so that that the number and/or size of air bubbles in the impregnated or wetted fiber material is reduced. Accordingly, the number and/or size of dry spots in the formed fiber-reinforced plastic parts may be reduced. Thus, the mechanical properties of the formed fiber-reinforced plastic parts may be improved.

According to embodiments of the present invention, the sound source is an infrasound source. The frequency of the infrasound vibration is typically in a range from about 0.1 Hz to about 40 Hz, more typically in a range from about 2 Hz to about 20 Hz. Accordingly, the speed of resin penetration into the fiber material may be increased. For example, it has been found that the speed of wetting a fiber material can be increased by about 25% to about 80% by applying an infrasound vibration of about 5 Hz to 10 Hz.

According to other embodiments of the present invention, the sound source is an ultrasound source. Accordingly, the number and/or size of air bubbles in the impregnated or wetted fiber material may be reduced.

According to embodiments of the present invention, the mold 100 is also exposed to vibrations during impregnation or wetting of the fiber material 500. Typically, the power density of the sound field is chosen such that the vibration of the mold 100 and/or the fiber material 500 is haptically perceptible, e.g. by touching the mold 100 and the fiber material 500, respectively, with a finger tip. Haptically perceptible infra-sound vibrations of the mold 100 have been found to result in the mentioned increase of wetting speed of up to 80%. The power density of the sound field may be constant or varying.

According to embodiments, the fiber material 500 consists essentially of loose fibers. In other embodiments, the fiber material 500 includes a woven fabric, a non-woven fabric or a roving. In further embodiments, the fiber material 500 essentially consists of a woven fabric, a non-woven fabric or a roving. It is, however, also possible to use a combination of different fiber materials 500 in the mold 100.

According to embodiments, the sound source 50 produces longitudinal sound waves which propagate essentially parallel to a main alignment direction of the fiber material. For example, the longitudinal waves may propagate along rovings which are placed in mold 100 essentially parallel to each other.

According to further embodiments, the sound source 50 produces longitudinal waves which propagate essentially perpendicular to a main alignment direction of the fiber material. The fiber material may have more than one main alignment directions. For example, a biaxial fiber mat has two main alignment directions. Accordingly, a longitudinal wave may at the same time propagate essentially parallel to a first alignment direction and essentially perpendicular to a second alignment direction of the fiber material.

According to embodiments, the sound source 50 is movable relative to the mold 100. Accordingly, the sound source 50 may produce longitudinal waves which propagate at different time intervals essentially parallel and perpendicular, respectively, to a main alignment direction of the fiber material. Furthermore, the sound source may be rotatable about a main alignment direction. Accordingly, the propagation direction of the longitudinal waves may rotate about an alignment direction of the fiber material.

According to embodiments of the invention, a fiber-reinforced plastic part is formed in the mold 100 by curing the resin of the resin impregnated fiber material. Depending on the resin type, curing may be done by thermosetting or UV-exposure. Activation of curing larger fiber composites is typically done by heating of the resin 550.

According to some embodiments, the mold 100 is only used for vibration-supported impregnating of the fiber material 500. Accordingly, a pre-impregnated composite of fibers with improved properties, e.g. with regard to enclosed air bubbles, may be formed in the mold 100. Pre-impregnated composite of fibers usually take the form of a weave or are uni-directional such as pre-impregnated rovings. The pre-impregnated composite may however also take the form of a woven or stitched fabric such as a biaxial, triaxial or quadraxial material.

FIG. 5 schematically illustrates an embodiment of a mold 200 for forming a fiber-reinforced plastic part. The mold 200 of FIG. 5 is similar to the mold 100 of FIG. 4. However, instead of using a sound source above the mold, two sound sources 50 and 51 are directly coupled to the mold 200. Accordingly, the vibrations generated by sound sources 50, 51 are transmitted via the body of mold 200 to the fiber material 500 and the resin 550 during resin infusion. Coupling one or more sound sources directly to the mold 200 may result in a more homogeneous exposure of the fiber material 500 and the penetrating resin to the sound field. Accordingly, the product quality of the cured fiber-reinforced plastic part may further be improved. Typically, this is particularly useful for larger parts and/or parts capable of carrying heavier mechanical loads such as spar caps of rotor blades. The sound sources 50, 51 may be, for example loud speakers, ultrasound transducers, shakers or vibration sanders.

According to further embodiments of the invention, the sound sources produce a sound field such that longitudinal waves propagate in the fiber material and/or the resin essentially parallel and/or perpendicular to a main alignment direction of the fiber material. The sound sources may be arranged such that the propagation direction of longitudinal waves may rotate about an alignment direction of the fiber material. The sound sources may emit sound of equal frequency compositions or of different frequency compositions. For example, one sound source may emit an infrasound for improving the penetration speed, and another sound source may emit an ultrasound for improving the degassing.

According to other embodiments, at least some of the sound sources emit sound in parallel. The sound emission pattern of the sound sources may be time-dependent. For example, the sound emission pattern may vary depending on the progress of the resin penetration into the fiber material. For example, the power density of the sound field may be decreased over time and, thus, energy may be saved.

FIG. 6 schematically illustrates an embodiment of a mold 300 for forming a fiber-reinforced plastic part. The mold 300 of FIG. 6 is similar to the molds 100 and 200 of FIG. 4 and of FIG. 5, respectively. The mold 300 of FIG. 6 is further equipped with a resin reservoir 120, a vacuum pump 130, a vacuum bag 150 enclosing a fiber material 500, and tubings 110, 111. Tubings 110 and 111 connect the vacuum bag with the vacuum pump 130 and the resin reservoir 120, respectively.

As indicated by the arrows above tubings 110, the vacuum bag 150 is laterally evacuated via the tubings 110 during infusion. Accordingly, the resin 550 flows from the reservoir 120 through the tubing 111 to the vacuum bag 150 as indicated by the arrow above tubing 111. In doing so, the resin is sucked into the fiber material 500. According to embodiments, this process is supported by vibrations which are induced in the resin 550 and the fiber material 500 by one or more sound sources 50 attached to the mold 300. Accordingly, the output of the mold and/or the quality of the cured products may be improved.

Fiber materials with high fiber volume content are typically used to form fiber-reinforced plastic parts capable of carrying heavy mechanical load. For example, spar caps are typically formed using stacks of biaxial fiber mats of high fiber volume content or roving. Mechanically strong yet lightweight spar caps can be formed by the process described. In particular, the vibration-enhanced resin impregnation results in higher throughput and simultaneously improved product quality.

According to further embodiments of the invention, nano-particulate fillers, like Al₂O₃ particles or silica particles, are added to the resin. The fillers are typically present in the composition in a range of from about 10% to about 80%, and more typically in a range of from about 30% to about 45% by weight, based on the total weight of the fiber composite. Accordingly, fiber-reinforced plastic parts such as spar caps may be further strengthened. In particular, the compression strength of a carbon fiber-reinforced plastic part may be increased. For example, the compression strength of a unidirectional carbon fiber composite may be increased by about 34% by adding 38% by weight of nano particles. Typically, the size of the nanoparticles is in a range from about 5 nm to about 500 nm, more typically in a range from about 10 nm to about 50 nm. Depending on the concentration and the size of the nanoparticles, the viscosity of the resin may be increased up to two orders of magnitude or even more. Accordingly, the speed of wetting a fiber material with a resin having nano-particulate fillers is typically reduced. The wetting speed for a resin with nano-particulate fillers may, however, be significantly reduced by vibrations during wetting or impregnating the fiber material.

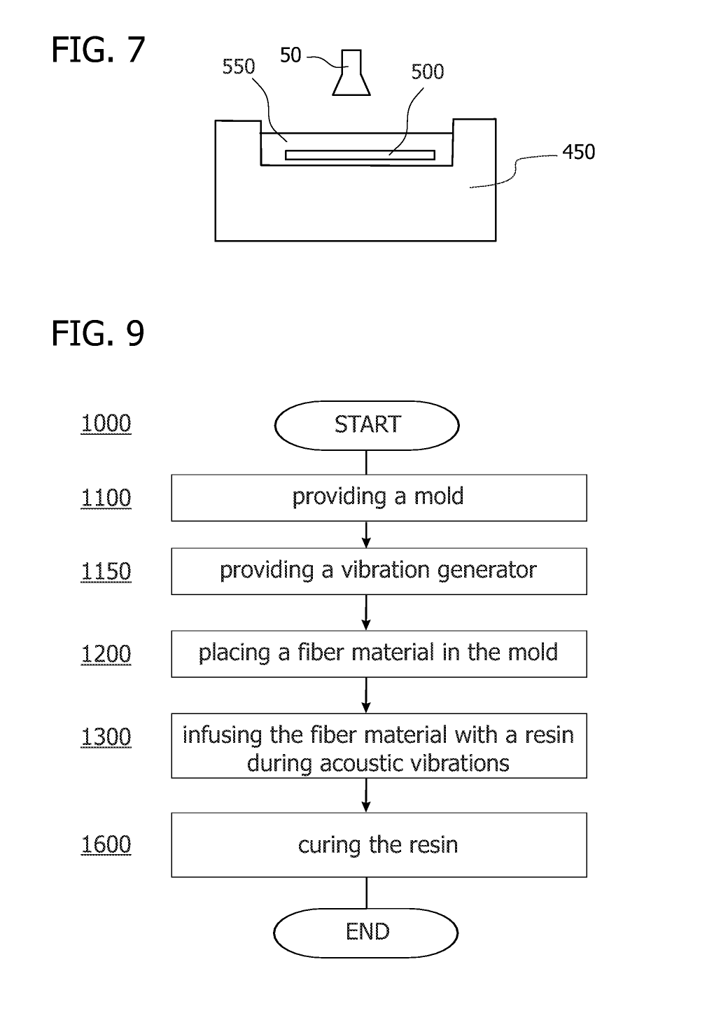

FIG. 7 schematically illustrates an embodiment of a vessel or resin bath 450 for impregnating a fiber material 500 with a resin 550. The resin bath 300 is equipped with a sound source 50. In the embodiment of FIG. 7, the sound source 50 is arranged above the mold 100. However, in other embodiments the sound source 50 is attached to the body of the resin bath 300 or in direct mechanical contact with the resin 550.

A fiber material 500 is immersed in and pulled through the resin 550 while exposing the resin to a sound field. Due to inducing vibrations in the resin 550 and fiber material 500, the fiber material 500 may be faster and/or better impregnated with the resin 550. Accordingly, the dwell in the resin bath 300 may be reduced and/or the quality of the impregnated fiber material may be improved.

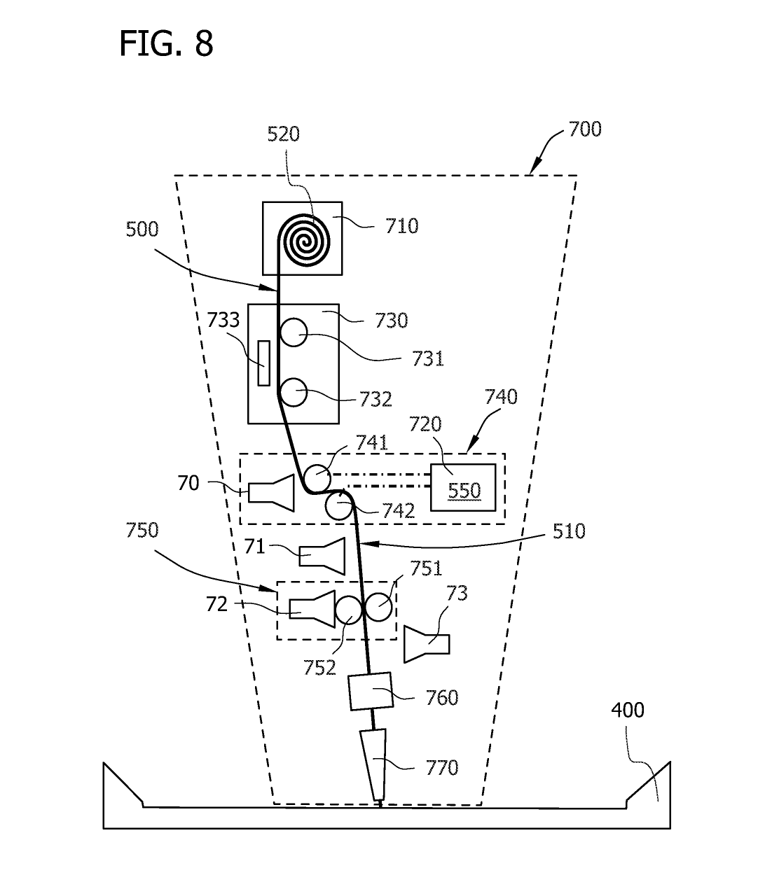

FIG. 8 schematically illustrates an embodiment of a mold 400 and an apparatus 700 for impregnating a fiber material 500 with a resin. Apparatus 700 includes a supply unit 710 containing the fiber material 500. For example, the fiber material 500 may be stored as a roll or wound fiber material pack 520 as illustrated in FIG. 8. The fiber material 500 may, for example, include one or more rovings stored in respective spindles 520. Alternatively, the apparatus 700 may include an input unit (not shown) for receiving the fiber material, e.g. fiber mats from a conveyor.

Apparatus 700 includes a preheating unit 730 through which fiber material 500 runs. The fiber material 500 passes a heater 733 arranged between two guide rollers 731 and 732 of the unit 730. Depending on the specific material, fiber material 500 is typically preheated from about 40° C. to about 60° C. Accordingly, the subsequent process of impregnating the fiber material 500 may be improved.

The apparatus 700 typically includes an impregnating or wetting unit 740 through which the fiber material 500 is fed. For example, the impregnating or wetting unit 740 includes at least one sound source 70 for enhancing the wetting process and impregnating process, respectively, by applying a sound field.

In the embodiment of FIG. 8, the impregnating unit 740 includes two infusion rollers 741 and 742. The infusion rollers 741 and 742 wet the fiber material 500 with a resin 550 provided from a reservoir 720 as indicated by the dash-dotted lines. The sound source 70 may cause vibration of the resin 550 and the fiber material 500 by transmitting a sound field via air. Alternatively, one or two sound sources may be directly coupled to one or both infusion rollers 741 and 742. Accordingly, one or both infusion rollers 741 and 742 vibrate and transfer the vibration to the passing fiber material 500 and the resin 550.

In other embodiments, unit 740 includes a resin bath in which the fiber material is immersed while the resin and the fiber material are exposed to vibrations.

Depending on the specific material, the fiber material is typically fed through unit 740 and apparatus 700 with a speed of about 0.5 m/min to about 5 m/min. Due to vibration-enhanced wetting and impregnating, respectively, the throughput of apparatus 700 may be increased and/or the quality of the impregnated fiber material improved.

According to further embodiments, the fiber material 500 is exposed to a sound field after wetting with the resin 550 in unit 730. Accordingly, the impregnation may be further improved. For this purpose one or more sound sources 71, 72 and 71 are provided in the apparatus 700. The resin-wetted fiber material 510 may be exposed to a sound field via air as indicated for the sound sources 71 and 73 or via additional rollers 751.

According to the embodiment of FIG. 8, the apparatus 700 further includes a pressing unit 750 with two pinch rollers 750, 751. Pinch rollers 750, 751 press the resin-wetted fiber material 500. For example, the fiber material 500 is provided as a roving having a circular cross-section. The pinch rollers 750, 751 may be used for flattening the roving. Accordingly, the circular cross-section of the roving is transformed to a rectangular one so that the roving can subsequently be more densely placed into a mold 100. Pinch roller 752 is coupled to a sound source 72. Accordingly, pinch roller 752 vibrates and transfers the vibration to the passing resin-wetted fiber material 500. Accordingly, the resin impregnation of the resin-wetted fiber material 500, i.e. the resin-wetted roving, may be further improved by vibrations. Alternatively, the sound source may be integrated into the pinch roller 752. Furthermore, it is also possible that both pinch rollers 750, 751 are coupled to a sound source or include a sound source or vibration generator.

In some embodiments, at least one of the sound sources 70 to 73 is an infrasound source. Infrasound has been found to be particularly useful for enhancing the penetration and impregnation, respectively, of a fiber material, in particular a fiber material with a high fiber volume content and/or a fiber material having only narrow spacing between the fibers such as a roving. However, the sound sources may also be ultrasound sources.

According to the embodiments shown in FIG. 8, the apparatus 700 further includes a pulling unit 760 which pulls the fiber material 500 from supply unit 710 through preheating unit 730, impregnating unit 740 and pressing unit 750

Typically, apparatus 700 further includes a dispensing unit 770 for outputting impregnated fiber material 510 into a mold 400.

Typically, the dispensing unit 770 is movable relative to the mold 400 such that the apparatus 700 may lay the impregnated fiber material 510 into mold 100.

In a subsequent resin curing block, a fiber-reinforced plastic part is typically formed in the mold 400. For example, a spar cap of a wind turbine rotor blade, a shear web of a wind turbine rotor blade, a blade halve of wind turbine rotor blade, or a part of a wind turbine nacelle may be formed in the mold 400.

In the following, methods for forming fiber-reinforced plastic parts are explained with respect to FIGS. 9 to 13.

FIG. 9 illustrates a method 1000 for forming a fiber-reinforced plastic part according to an embodiment. The method 1000 includes a block 1100 for providing a mold and a block 1150 for providing a vibration generator. The vibration generator may be a loud speaker, an ultrasound transducer, a shaker or a vibration sander. The vibration generator is arranged such that the interior of the mold and/or the mold body can be exposed to a sound field. The vibration generator may, for example, be directly coupled to the mold. The size and inner shape of the mold is typically chosen in accordance with the part to be formed. For example, the mold may have a longitudinal extension of several 10 meters in case a spar cap or rotor blade is to be formed. Further, several vibration generators may be provided in block 1150. For example, several vibration generators may be arranged along the longitudinal extension and above the mold to expose the mold interior to a sound field.

Subsequently, a fiber material, e.g. a stack of biaxial fiber mats or a pressed roving, is placed in the mold in a block 1200. The vibration generator is typically arranged such that a sound field can be applied to the fiber material in the mold.

According to embodiments of the invention, the method 1000 further includes a block 1300 for infusing the fiber material with a resin while the fiber material and the resin are exposed to vibrations produced by the vibration generator.

In a subsequent block 1600, the resin is cured and thus a fiber-reinforced plastic part formed. Curing may be done by UV-exposure or thermosetting. Typically, larger fiber composites are cured by heat.

As explained above, vibrations may result in a reduced viscosity of the resin and, thus, in an increased penetration speed of the resin into the fiber material and/or in a more uniform resin distribution in the fiber material. Accordingly, the time of the overall curing cycle may be reduced. Furthermore, the resin may be adjusted to a shorter pot life. Thus, the production capacity of the mold may be increased and the costs of the formed fiber-reinforced plastic parts reduced. Further, the number and/or size of trapped air in the fiber-reinforced plastic parts may be reduced. Thus, the mechanical properties of the fiber-reinforced plastic parts may be improved.

According to an embodiment, the fiber material is vacuum-infused in block 1300. Thereby, larger parts of fiber material may be uniformly impregnated with the resin. The vacuum-infusion process may be speeded up and/or the product quality improved by applying a sound field during infusing the fiber material.

According to a further embodiment, the fiber material and the resin are exposed to vibrations prior to curing. Accordingly, the resin impregnation is improved. It is, however, also possible that curing, or partial curing, sets within the infusion block 1300.

According to yet another embodiment, the infusion process in block 1300 is carried out above room temperature to further increase the viscosity of the resin. Accordingly, the wetting speed can be further increased. In case of a thermosetting resin, the temperature of the resin is typically below the curing temperature within the infusion block 1300. Typically, the resin temperature ranges from about 30° C. to about 50° C. during block 1300.

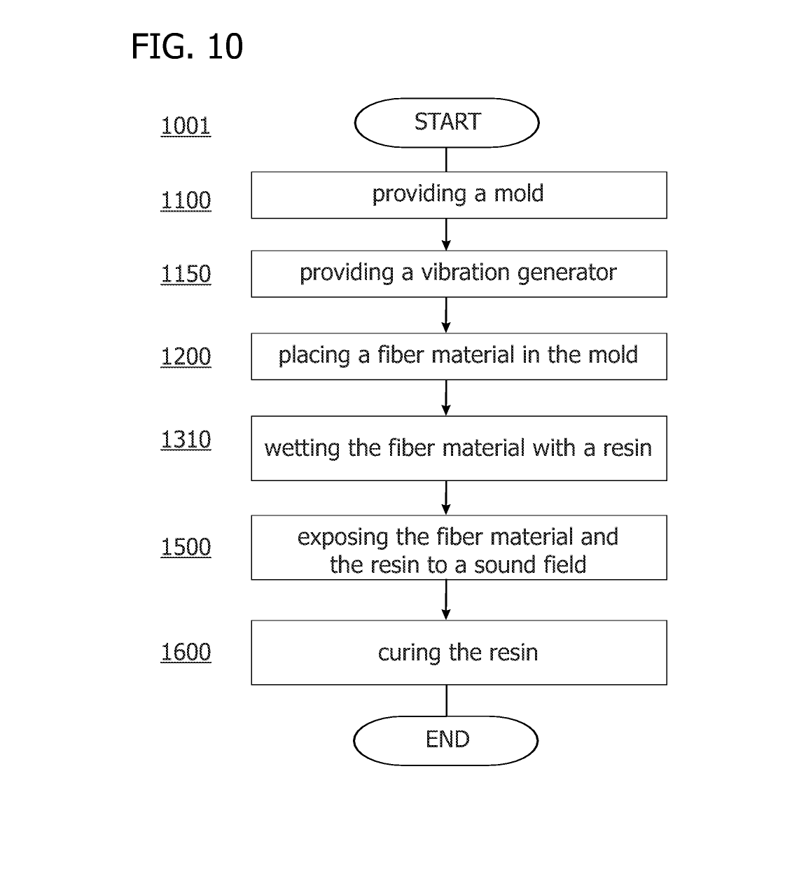

FIG. 10 illustrates another method 1001 for forming a fiber-reinforced plastic part according to an embodiment. The method 1001 typically includes a block 1100 for providing a mold, a block 1150 for providing a vibration generator, and a block 1200 for placing a fiber material in the mold, as with block 1000 of FIG. 9. The method 1001 further includes a block 1310 for wetting a fiber material with a resin and a subsequent block 1500 for exposing the fiber material and the resin, i.e. the resin-wetted fiber material, to a sound field, i.e. to vibrations. Exposing the resin-wetted fiber material to vibrations may speed up the resin penetration into, and/or improve the uniformity of the resin distribution in, the fiber material. Accordingly, the overall processing time may be reduced and/or the quality of the fiber-reinforced plastic part, which is formed in a subsequent block 1600 for curing the resin, may be improved.

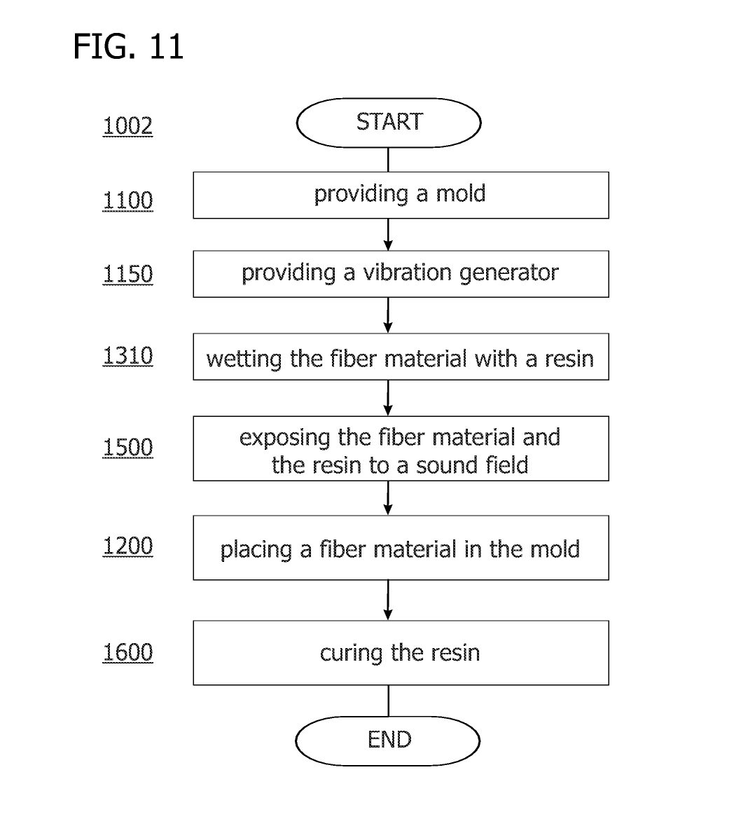

FIG. 11 illustrates yet another method 1002 for forming a fiber-reinforced plastic part according to an embodiment. The method 1002 of FIG. 11 is similar to the method 1001 of FIG. 10. However, the order of blocks is different. In the embodiment of FIG. 11, the fiber material is placed in the mold in block 1200 after the blocks 1310 and 1500 for wetting the fiber material with a resin and exposing the fiber material and the resin to a sound field, respectively. Method 1002 may, for example, be carried out by the apparatus 700 explained with reference to FIG. 8.

According to an embodiment, the fiber material used in method 1002 is a roving. Accordingly, the roving is wetted with a resin in block 1310. Thereafter, the resin wetted roving is exposed to a sound field in block 1500 and laid into the mold as resin impregnated roving in block 1200.

The use of vibration facilitates the impregnation of fiber material with high fiber volume content. For example, rovings having more than 12,000 filaments, e.g. about 24,000 filaments, 48,000 filaments or even more filaments may be resin impregnated in a vibration-supported impregnating process.

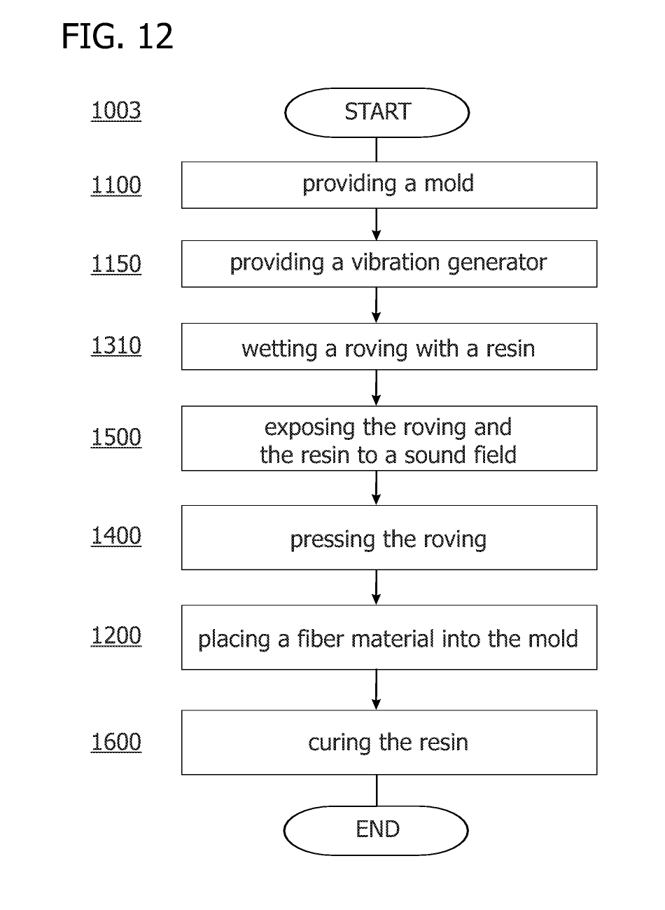

FIG. 12 illustrates a further method 1003 for forming a fiber-reinforced plastic part according to embodiments. The method 1003 of FIG. 12 is similar to the method 1002 of FIG. 11 and may also be carried out by the apparatus 700 explained with reference to FIG. 8. Method 1003 of FIG. 12 is used for rovings. It further includes a block 1400 for pressing the roving between the blocks 1500 and 1200. Pressing the roving changes its cross-section from circular to substantially rectangular. Accordingly, the roving can be more densely packed in the mold. Thus the mechanical strength of the fiber-reinforced plastic part cured in a subsequent block 1600 is increased.

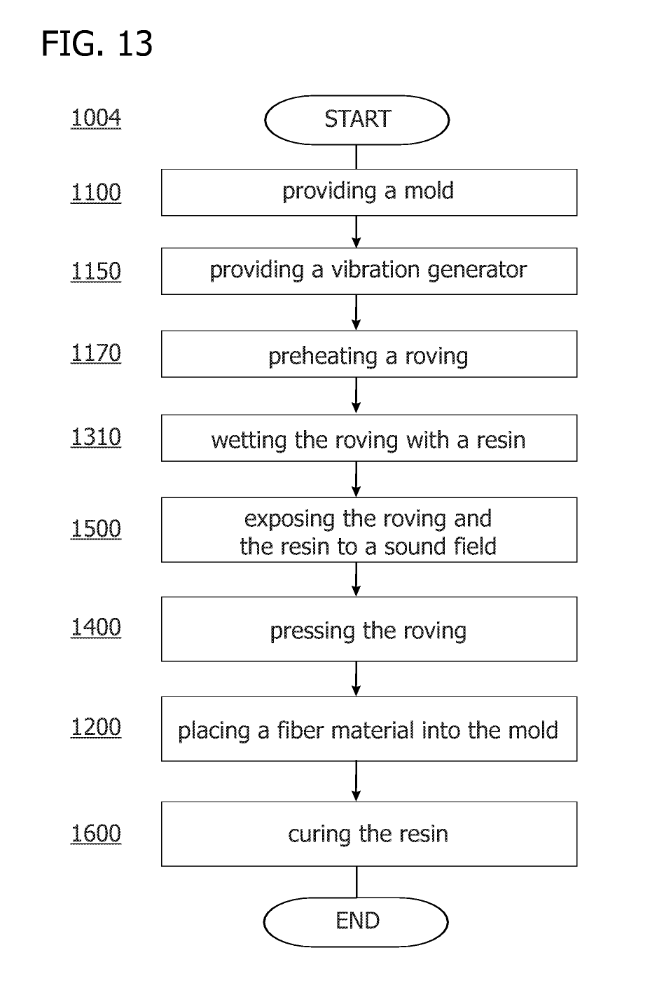

FIG. 13 illustrates a further method 1004 for forming a fiber-reinforced plastic part according to embodiments. The method 1004 of FIG. 13 is similar to the method 1003 of FIG. 12 and may also be carried out by the apparatus 700 explained with reference to FIG. 8. Method 1004 of FIG. 13 further includes a block 1170 for preheating the roving. Accordingly, the subsequent process of wetting the roving in block 1310 may be improved.

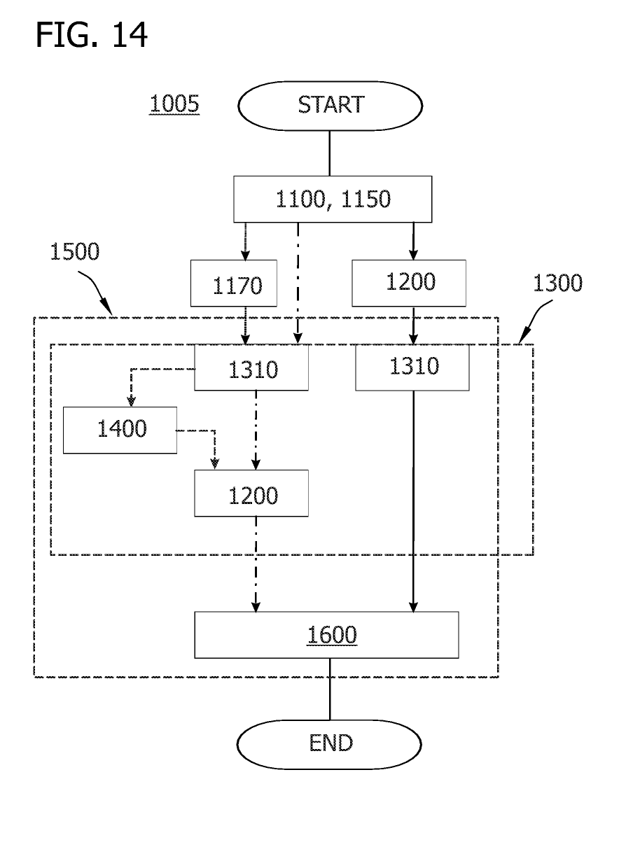

FIG. 14 illustrates a method scheme 1005 for forming a fiber-reinforced plastic part according to embodiments. The methods of scheme 1005 include initial blocks 1100 and 1150 for providing a mold and a vibration generator, respectively. Further, the method scheme 1005 includes a block 1310 for wetting a fiber material with a resin, a block 1200 of placing the fiber material in the mold, a block 1500 for exposing the resin and/or the fiber material to vibrations and a sound field, respectively, and a final block 1600 for curing the resin. The block 1500 for exposing vibrations may be carried out once or several times during a time interval corresponding to the vertical extension of the dashed rectangle 1500. Accordingly, each sequence of blocks in FIG. 14, which are represented by arrows, correspond to a class of manufacturing methods. Further, each class includes several manufacturing methods with different time schedules for carrying out block 1500 of applying a sound field. Each of the methods 1000 to 1004 explained with reference to FIGS. 9 to 13 may be represented by a manufacturing method of scheme 1005.

According to embodiments of the invention, block 1500 is carried out in parallel to and/or after block 1310. Accordingly, the penetration of the resin into the fiber material may be speed up and/or improved with respect to uniformity of the resin distribution and entrapping air bubbles in the fiber material.

One of the methods corresponding to the sequence indicated by full arrows represents method 1000 of FIG. 9. Furthermore, one of the methods corresponding to the dashed-dotted arrows represents method 1002 of FIG. 11.

According to an embodiment, the block 1500 may already be used to degas the resin and/or to reduce the viscosity of the resin prior to wetting the fiber material with the resin in block 1310.

According to a further embodiment, a block 1400 for pressing a fiber material, typically a roving, is used between the blocks 1310 and 1200. These methods correspond to a sequence of blocks which includes the sub-path indicated by dashed arrows. One of these methods represents the method 1003 of FIG. 12.

According to still a further embodiment, a block 1170 for preheating a fiber material, typically a roving, is used prior to block 1310. These methods correspond to a sequence of blocks which include the sub-path indicated by dotted arrows. One of these methods represents the method 1004 of FIG. 13.

According to yet a further embodiment, block 1500 is carried out prior to curing the resin in block 1600. The block 1500 may, however, also extend into the curing block 1600.

According to an embodiment, block 1310 is carried out as a vibration-enhanced infusion process, typically a vibration-enhanced vacuum infusion process, as indicated by the dashed rectangle 1300. This means that the resin is pushed or sucked through the fiber material while a sound field is applied to the resin and the fiber material. Accordingly, one of the methods corresponding to the full arrows represents the method 1000 of FIG. 9.

The above-described apparatuses and methods facilitate a faster and/or more uniform infusion and/or impregnation of the fiber material with the resin by exposing at least the resin, typically also the fiber material, to vibrations. Further, size and probability of dry spots in the fiber-reinforced plastic part may be reduced. Accordingly, fiber reinforced plastic parts produced according to the methods described herein may have improved mechanical properties and/or shorter curing cycles.

Exemplary embodiments of systems and methods for forming a fiber-reinforced plastic part are described above in detail. The systems and methods are not limited to the specific embodiments described herein, but rather, components of the systems and/or steps of the methods may be utilized independently and separately from other components and/or steps described herein. The embodiments are not limited to practice with respect to the wind turbine rotor blades as described herein. Rather, the exemplary embodiment can be implemented and utilized in connection with many other applications of fiber-reinforced plastic parts. For example, aircraft wings or parts thereof, blades of an aircraft propeller or a helicopter propeller and a vehicle housing or parts thereof may be manufactured with the embodiments of systems and method disclosed herein. Furthermore, smaller fiber-reinforced plastic parts such as housings for medical equipment may be manufactured with the embodiments of systems and method disclosed herein. Using carbon-fiber-reinforced plastic parts for housing medical equipment typically improves antistatic properties of the equipment. The higher speed of resin penetration allows for a higher throughput of the mold. Thus, the manufacturing cost may be reduced also for smaller fiber-reinforced plastic parts.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forming a fiber-reinforced plastic part, comprising:
a) providing a mold;
b) providing a vibration generator;
c) placing a fiber material in the mold;
d) infusing the fiber material with a resin while the fiber material and the resin are exposed to vibrations; and,
e) curing the resin.

2. The method of claim 1, wherein the fiber material is exposed to vibrations prior to curing.

3. The method of claim 1, wherein the fiber material is vacuum-infused.

4. The method of claim 1, wherein the fiber material and the resin are exposed to infrasound or ultrasound.

5. The method of claim 1, wherein the frequency of the vibration is in a range from about 2 Hz to about 20 Hz.

6. The method of claim 1, wherein the fiber material is selected from a group consisting of a woven fabric, a non-woven fabric and a roving.

7. The method of claim 1, wherein the fiber material is selected from a group consisting of a biaxial fiber mat, a stack of biaxial fiber mats, and a pressed roving.

8. The method of claim 1, wherein the fiber material comprises a fiber content between about 55 vol. % to about 58 vol. %.

9. The method of claim 1, wherein the resin has a temperature in a range of about 30° C. to about 50° C. during infusing the fiber material.

10. The method of claim 1, wherein the resin comprises nanoparticles.

11. The method of claim 1, wherein the fiber-reinforced plastic part is selected from a group consisting of a blade of a helicopter propeller, a blade of an aircraft propeller, a spar cap of a wind turbine rotor blade, a shear web of a wind turbine rotor blade, a blade halve of wind turbine rotor blade, a nacelle or parts thereof.

12. A method for forming a fiber-reinforced plastic part, comprising:
a) providing a mold;
b) providing a vibration generator for generating a sound field;
c) wetting a fiber material with a resin;
d) exposing the fiber material and the resin to a sound field;
e) placing the fiber material in the mold; and,
f) curing the resin.

13. The method of claim 12, wherein the fiber material is a roving, further comprising:
pressing the roving.

14. The method of claim 13, wherein the roving is exposed to a sound field during at least one of:
wetting the roving; and,
pressing the roving.

15. The method of claim 13, wherein the roving comprises more than 12,000 filaments.

16. The method of claim 12, wherein the fiber material is exposed to a sound field in the mold or in a resin bath provided for wetting the fiber material with a resin.

17. The method of claim 12, wherein the fiber material is exposed to a sound field prior to curing.

18. The method of claim 12, further comprising:
preheating the fiber material prior to wetting the fiber material with the resin.

19. An apparatus for impregnating a fiber material with a resin, the apparatus being selected from a group consisting of an apparatus comprising a mold for infusing the fiber material with the resin and a sound source which is adapted to expose the fiber material and the resin to a sound field during infusing; an apparatus comprising at least one infusion roller for wetting the fiber material with the resin and a sound source which is adapted to expose the fiber material and the resin to a sound field when the fiber material passes the at least one infusion roller and/or after passing the at least one infusion roller; and an apparatus comprising at least one pinch roller adapted to press the fiber material wetted with the resin and a sound source which is adapted to expose the fiber material wetted with the resin to a sound field prior to and/or during and/or after passing the at least one pinch roller.

20. The apparatus of claim 19, wherein the sound source is an infrasound source or ultrasound source.
